(19) United States
(12) Patent Application Publication
(10) Pub. No.: US 2012/0002237 A1
(43) Pub. Date: Jan. 5, 2012

(54) PRINTER AND CONTROL METHOD THEREFOR

(75) Inventor: Norio Kurosawa, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/171,383

(22) Filed: Jun. 28, 2011

Related U.S. Application Data
(60) Provisional application No. 61/360,456, filed on Jun. 30, 2010.

(51) Int. Cl. G06K 15/02

(52) U.S. Cl. 358/1.15

(57) ABSTRACT

According to one embodiment, a printer includes plural control units having a high rank and low rank relation with one another and serially connected in order from a high rank control unit to a low rank control unit. The low rank control unit notifies the high rank control unit of a download condition for the low rank control unit. The high rank control unit determines, if data to be downloaded to the low rank control unit is input from the outside, whether the accepted data meets the notified download condition and transfers, if the input data meets the download condition, the input data to the low rank control unit.

### CROSS-REFERENCE TO RELATED APPLICATIONS

This application is based upon and claims the benefit of priority from U.S. Provisional Application No. 61/360,456, filed on Jun. 30, 2010, the entire contents of which are incorporated herein by reference.

### FIELD

Embodiments described herein relate generally to a printer including plural control units and a control method for the printer.

### BACKGROUND

There is known a printer including plural controls units that are serially connected in the order of ranks set in advance (e.g., JP-A-08-147171).

In such a printer, when data to be downloaded to a subordinate control unit is sent from the outside, the data is received in a high rank control unit and the received data is transferred to the subordinate control unit.

In some case, the subordinate control unit does not accept the data transferred to the subordinate control unit. In this case, time required for the transfer of data from the high rank control unit to the subordinate control unit is wasted.

### BRIEF DESCRIPTION OF THE DRAWINGS

FIG. 1 is a block diagram of the configuration of a printer according to embodiments;

FIG. 2 is a flowchart for explaining control by a third control unit according to the embodiments;

FIG. 3 is a flowchart for explaining control by a second control unit according to a first embodiment;

FIG. 4 is a flowchart for explaining control by a first control unit according to the first embodiment;

FIG. 5 is a flowchart for explaining control by a second control unit according to a second embodiment;

FIG. 6 is a flowchart for explaining control by a first control unit according to the second embodiment;

FIG. 7 is a flowchart for explaining control by a second control unit according to a third embodiment;

FIG. 8 is a flowchart for explaining control by a first control unit according to a third embodiment;

FIG. 9 is a block diagram of the configuration of a printer according to a modification of the embodiments; and

FIG. 10 is a block diagram of the configuration of a printer according to another modification of the embodiments.

### DETAILED DESCRIPTION

In general, according to one embodiment, a printer includes first, second, and third control units having a high rank and low rank relation with one another and serially connected in order from a high rank control unit to a low rank control unit; a third control section arranged in the third control unit and configured to notify the second control unit of a third download condition for the third control unit; a second control section arranged in the second control unit and configured to notify the first control unit of a second download condition for the second control unit, notify the first control unit of a third download condition notified from the third control unit, and transfer, if third data to be downloaded to the third control unit is transferred from the first control unit, the third data to the third control unit; and a first control section arranged in the first control unit and configured to determine, if second data to be downloaded to the second control unit is input from the outside, whether the second data meets the second download condition notified from the second control unit, transfer, if the second data meets the second download condition, the second data to the second control unit, determine, if the third data to be downloaded to third control unit is input from the outside, whether the third data meets the third download condition notified from the second control unit, and transfer, if the third data meets the third download condition, the third data to the second control unit.

[1] A first embodiment is explained below.

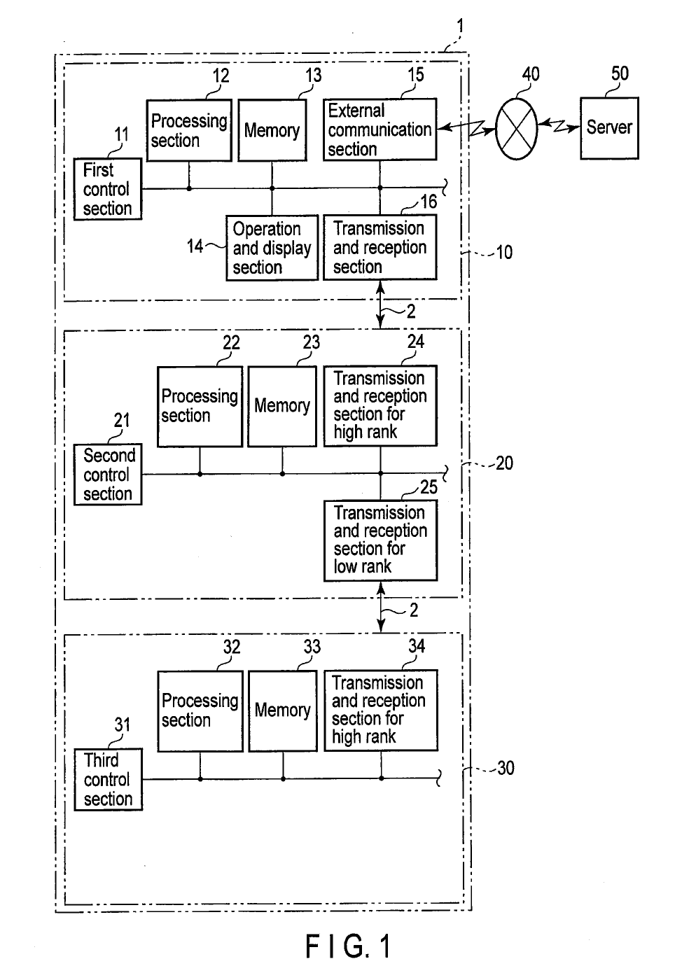

As shown in FIG. 1, a printer 1 includes a first control unit 10, a second control unit 20, a third control unit 30 that have a high rank and low rank relation with one another. In a relation between the first control unit 10 and the second control unit 20, the first control unit 10 is a high rank and the second control unit 20 is a low rank. In a relation between the second control unit 20 and the third control unit 30, the second control unit 20 is a high rank and the third control unit 30 is a low rank. The first control unit 10, the second control unit 20, and the third control unit 30 are serially connected via a data bus 2 in the order from the high rank control unit to the low rank control unit. The first control unit 10 is connected to a server 50 via a communication network 40.

The first control unit 10 includes a first control section 11. A processing section 12, a memory 13, an operation and display section 14, an external communication section 15, and a transmission and reception section 16 are connected to the first control section 11. The processing section 12 executes, on the basis of a control program and an application program in the memory 13, various kinds of processing for realizing functions peculiar to the first control unit 10. The operation and display section 14 receives operation by a user and displays various kinds of information to the user. The external communication section 15 performs data transmission and reception to and from the communication network 40. The transmission and reception section 16 performs data transmission and reception to and from the second control unit 20.

The control program and the application program necessary for the various kinds of processing by the processing section 12 are stored in the memory 13. A download condition (a first download condition) X1 for download to the first control unit 10 is stored in the memory 13. The download condition X1 is a condition for accepting download to the first control unit 10.

The second control unit 20 includes a second control section 21. A processing section 22, a memory 23, a transmission and reception section for high rank 24, and a transmission and reception section for low rank 25 are connected to the second control section 21. The processing section 22 executes, on the basis of a control program and an application program in the memory 23, various kinds of processing for realizing functions peculiar to the second control unit 20. The transmission and reception section for high rank 24 performs data transmission and reception to and from the first control unit 10. The transmission and reception section for low rank 25 performs data transmission and reception to and from the third control unit 30.

The control program and the application program necessary for the various kinds of processing by the processing section 22 are stored in the memory 23. A download condition (a second download condition) X2 for the second control unit 20 is stored in the memory 23. The download condition X2 is a condition for accepting download to the second control unit 20.

The third control unit 30 includes a third control section 31. A processing section 32, a memory 33, and a transmission and reception section for high rank 34 are connected to the third control section 31. The processing section 32 executes, on the basis of a control program and an application program in the memory 33, various kinds of processing for realizing functions peculiar to the third control unit 30. The transmission and reception section for high rank 34 performs data transmission and reception to and from the second control unit 20.

The control program and the application program necessary for the various kinds of processing by the processing section 32 are stored in the memory 33. A download condition (a third download condition) X3 for the third control unit 30 is stored in the memory 33. The download condition X3 is a condition for accepting download to the third control unit 30.

The third control section 31 includes control sections of (31) and (32) explained below.

(31) A control section configured to periodically notify the second control unit 20 of the download condition X3 in the memory 33.

(32) A control section configured to accept, if data (third data) D3 to be downloaded to the third control unit 30 is transferred from the second control unit 20, the data D3 and store the data D3 in the memory 33. The data D3 is, for example, control program data or application program data.

The second control section 21 includes control sections of (21) to (24) explained below.

(21) A control section configured to periodically notify the first control unit 10 of the download condition X2 in the memory 23.

(22) A control section configured to notify, if the download condition X3 is notified from the third control unit 30, the first control unit 10 of the download condition X3.

(23) A control section configured to accept, if data (second data) D2 to be downloaded to the second control unit 20 is transferred from the first control unit 10, the data D2 and store the data D2 in the memory 23. The data D2 is, for example, control program data or application program data.

(24) A control section configured to transfer, if data (third data) D3 to be downloaded to the third control unit 30 is transferred from the first control unit 10, the data D3 to the third control unit 30.

The first control section 11 includes control sections of (11) to (15) explained below.

(11) A control section configured to update and store, if the download condition X2 is notified from the second control unit 20, the download condition X2 in the memory 23.

(12) A control section configured to update and store, if the download condition X3 is notified from the second control unit 20, the download condition X3 in the memory 23.

(13) A control section configured to determine, if the data D3 to be downloaded to the third control unit 30 is input from the outside, whether the data D3 meets the updated and stored download condition X3, transfer, if the data D3 meets the download condition X3, the data D3 to the second control unit 20, and inform, if the data D3 does not meet the download condition X3, through display by the operation and display section 14, that the download to the third control unit 30 is error. An element for determining whether the data D3 meets the download condition X3 is added to a starting address of the data D3.

(14) A control section configured to determine, if the data D2 to be downloaded to the second control unit 20 is input from the outside, whether the data D2 meets the updated and stored download condition X2, transfer, if the data D2 meets the download condition X2, the data D2 to the second control unit 20, and inform, if the data D2 does not meet the download condition X2, through display by the operation and display section 14, that the download to the second control unit 20 is error. An element for determining whether the data D2 meets the download condition X2 is added to a starting address of the data D2.

(15) A control section configured to determine, if data (first data) D1 to be downloaded to the first control unit 10 is input from the outside, whether the data D1 meets the download condition X1 in the memory 13, accept, if the data D1 meets the download condition X1, the data D1 and store the data D1 in the memory 13, and inform, if the data D1 does not meet the download condition X1, through display by the operation and display section 14, that the download to the first control unit 10 is error. The data D1 is, for example, control program data or application program data. An element for determining whether the data D1 meets the download condition X1 is added to a starting address of the data D1.

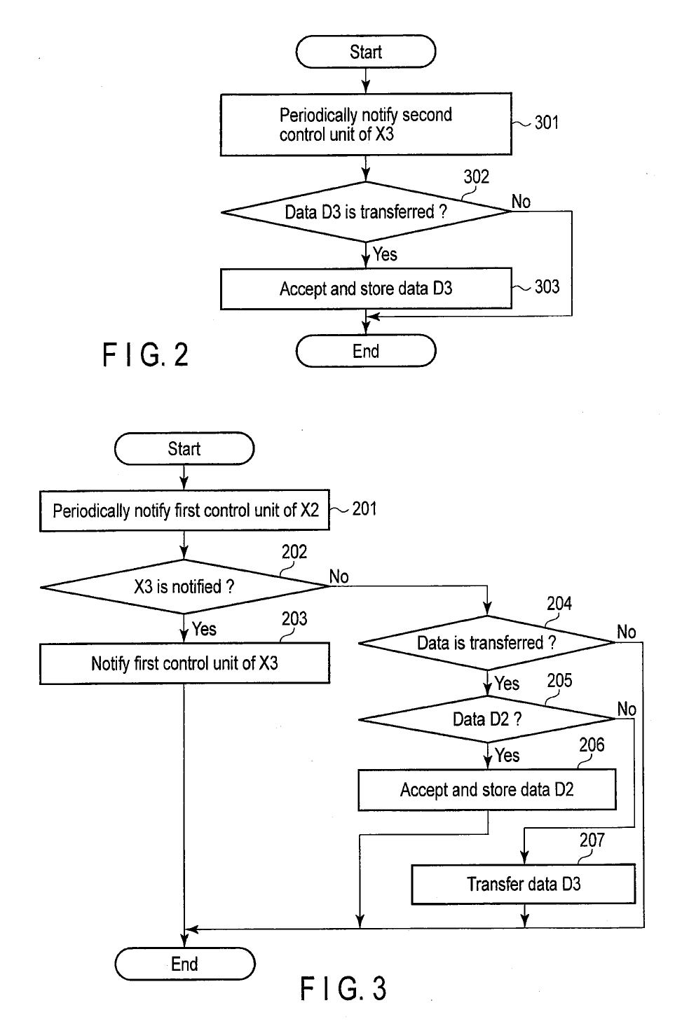

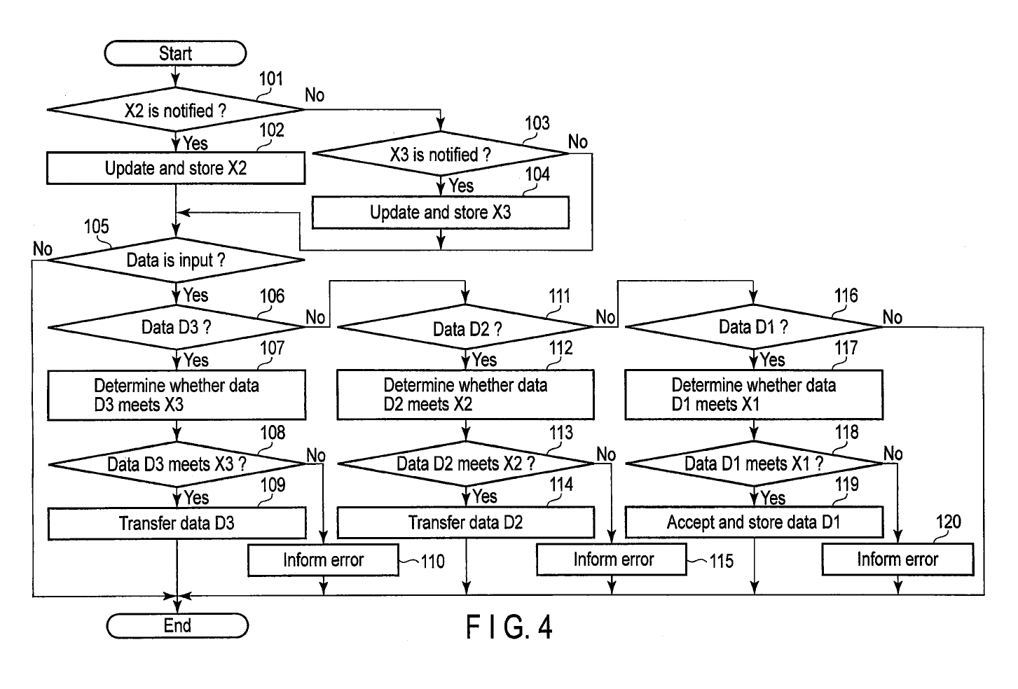

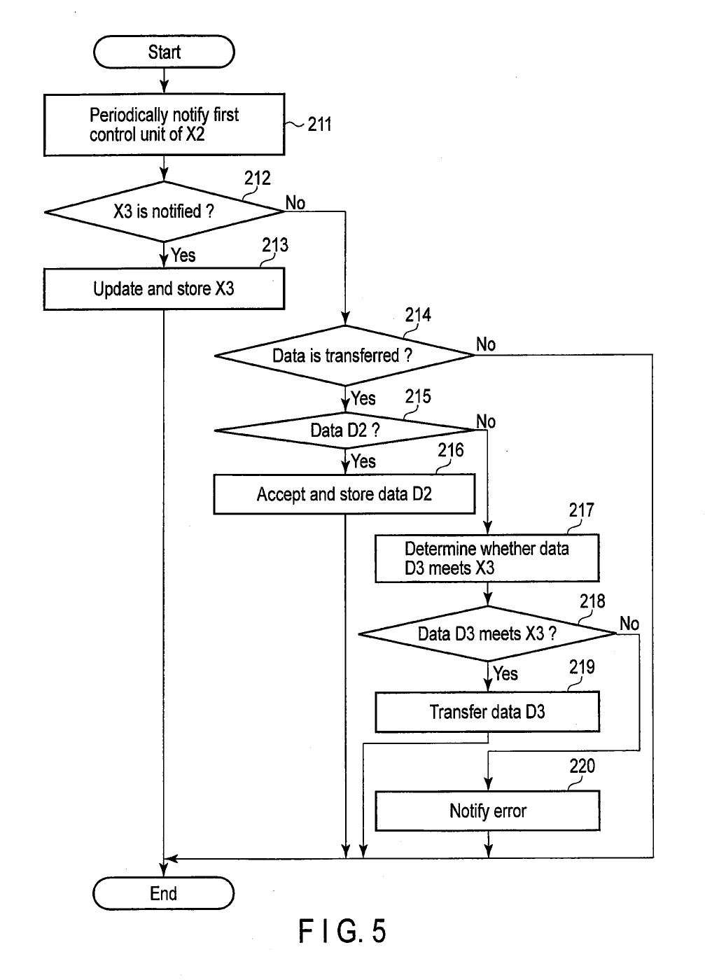

Control by the third control section 31 is shown in FIG. 2. Control by the second control section 21 is shown in FIG. 3. Control by the first control section 11 is shown in FIG. 4.

The third control section 31 periodically notifies the second control unit 20 of the download condition X3 in the memory 33 (Act 301). If the data D3 to be downloaded to the third control unit 30 is transferred from the second control unit 20 (YES in Act 302), the third control section 31 accepts the data D3 and stores the data D3 in the memory 33 (Act 303).

The second control section 21 periodically notifies the first control unit 10 of the download condition X2 in the memory 23 (Act 201). If the download condition X3 is notified from the third control unit 30 (YES in Act 202), the second control section 21 notifies the first control unit 10 of the download condition X3 (Act 203). If the data D2 to be downloaded to the second control unit 20 is transferred from the first control unit 10 (YES in Act 204 and YES in Act 205), the second control section 21 accepts the data D2 and stores the data D2 in the memory 23 (Act 206). If the data D3 to be downloaded to the third control unit 30 is transferred from the first control unit 10 (YES in Act 204 and NO in Act 205), the second control section 21 transfers the data D3 to the third control unit 30 (Act 207).

If the download condition X2 is notified from the second control unit 20 (YES in Act 101), the first control section 11 updates and stores the download condition X2 in the memory 23 (Act 102). If the download condition X3 is notified from the third control unit 30 (YES in Act 103), the first control section 11 updates and stores the download condition X3 in the memory 23 (Act 104).

If data transmitted from the server 50 is input to the first control unit 10 via the communication network 40 (YES in Act 105), the first control section 11 determines to which control unit the input data is to be downloaded (Acts 106, 111, and 116). If the input data is the data D3 to be downloaded to the third control unit 30 (YES in Act 106), the first control section 11 determines whether the data D3 meets the download condition X3 in the memory 13 (Act 107). If the data D3 meets the download condition X3 (YES in Act 108), the first control section 11 transfers the data D3 to the second control unit 20 (Act 109). If the data D3 does not meet the download condition X3 (NO in Act 108), the first control section 11 informs, through display by the operation and display section 14, that the download to the first control unit 10 is error (Act 110).

If the input data is the data D2 to be downloaded to the second control unit 20 (YES in Act 111), the first control section 11 determines whether the data D2 meets the download condition X2 in the memory 23 (Act 112). If the data D2 meets the download condition X2 (YES in Act 113), the first control section 11 transfers the data D2 to the second control unit 20 (Act 114). If the data D2 does not meet the download condition X2 (NO in Act 113), the first control section 11 informs, through display by the operation and display section 14, that the download to the second control unit 20 is error (Act 115).

If the input data is the data D1 to be downloaded to the first control unit 10. (YES in Act 116), the first control section 11 determines whether the data D1 meets the download condition X1 in the memory 13 (Act 117). If the data D1 meets the download condition X1 (YES in Act 118), the first control section 11 accepts the data D1 and stores the data D1 in the memory 13 (Act 119). If the data D1 does not meet the download condition X1 (NO in Act 118), the first control section 11 informs, through display by the operation and display section 14, that the download to the first control unit 10 is error (Act 120).

As explained above, the data D3 that does not meet the download condition X3 for the third control unit 30 is not transferred from the first control unit 10 to the second control unit 20. Therefore, useless data transfer processing can be prevented. A waste of time required for the data transfer processing can be eliminated. The user can easily grasp by looking at the display by the operation and display section 14 of the first control unit 10 that the download to the third control unit 30 is error. The first control unit 10 may inform, via the communication network 40, the server 50 that the download to the third control unit 30 is error.

The data D2 that does not meet the download condition X2 for the second control unit 20 is not transferred from the first control unit 10 to the second control unit 20. Therefore, useless data transfer processing can be prevented. A waste of time required for the data transfer processing can be eliminated. The user can easily grasp by looking at the display by the operation and display section 14 of the first control unit 10 that the download to the second control unit 20 is error. The first control unit 10 may inform, via the communication network 40, the server 50 that the download to the second control unit 20 is error.

The data D1 that does not meet the download condition X1 for the first control unit 10 is not accepted by the first control unit 10. The user can easily grasp by looking at the display by the operation and display section 14 of the first control unit 10 that the download to the first control unit 10 is error. The first control unit 10 may inform, via the communication network 40, the server 50 that the download to the first control unit 10 is error.

Since the download conditions X2 and X3 are periodically notified to the first control unit 10, even if the download conditions X2 and X3 are changed, it is possible to always perform appropriate download determination in the first control unit 10.

[2] A second embodiment is explained below.

The configuration of the printer 1 is the same as that shown in FIG. 1. The third control section 31 includes the control sections of (31) and (32) same as those in the first embodiment.

The second control section 21 includes controls sections of (21-1) to (24-1) explained below.

(21-1) A control section configured to periodically notify the first control unit 10 of the download condition X2 in the memory 23.

(22-1) A control section configured to update and store, if the download condition X3 is notified from the third control unit 30, the download condition X3 in the memory 23.

(23-1) A control section configured to accept, if the data D2 to be downloaded to the second control unit 20 is transferred from the first control unit 10, the data D2 and store the data D2 in the memory 23.

(24-1) A control section configured to determine, if the data D3 to be downloaded to the third control unit 30 is transferred from the first control unit 10, whether the data D3 meets the updated and stored download condition X3, transfer, if the data D3 meets the download condition X3, the data D3 to the third control unit 30, and inform, if the data D3 does not meet the download condition X3, the first control unit 10 that the download to the third control unit 30 is error.

The first control section 11 includes control sections of (11-1) to (15-1) explained below.

(11-1) A first storage control section configured to update and store, if the download condition X2 is notified from the second control unit 20, the download condition X2 in the memory 23.

(12-1) A control section configured to transfer, if the data D3 to be downloaded to the third control unit 30 is input from the outside, the data D3 to the second control unit 20.

(13-1) A control section configured to determine, if the data D2 to be downloaded to the second control unit 20 is input from the outside, whether the data D2 meets the updated and stored download condition X2, transfer, if the data D2 meets the download condition X2, the data D2 to the second control unit 20, and inform, if the data D2 does not meet the download condition X2, through display by the operation and display section 14, that the download to the second control unit 20 is error.

(14-1) A control section configured to determine, if the data D1 to be downloaded to the first control unit 10 is input from the outside, whether the data D1 meets the download condition X1 in the memory 13, accept, if the data D1 meets the download condition X1, the data D1 and store the data D1 in the memory 13, and inform, if the data D1 does not meet the download condition X1, through display by the operation and display section 14, that the download to the first control unit 10 is error.

(15-1) A control section configured to inform, if the control section is notified from the second control unit 20 that the download to the third control unit 30 is error, through display by the operation and display section 14, that the download to the third control unit 30 is error.

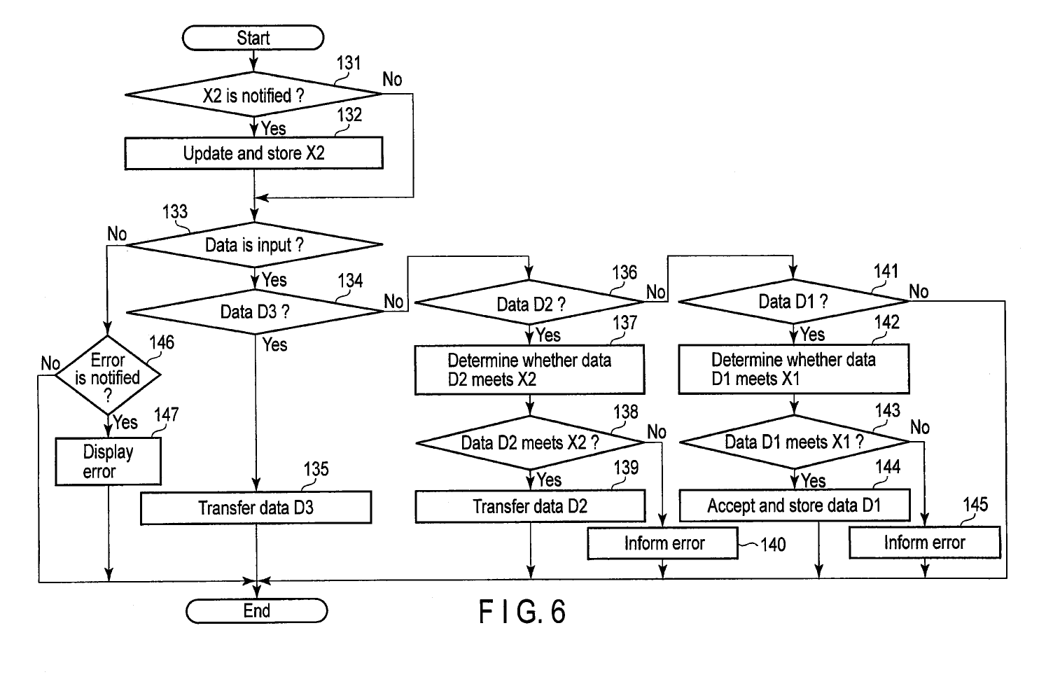

Since control by the third control section 31 is the same as that in the first embodiment, explanation of the control is omitted. Control by the second control section 21 is shown in FIG. 5. Control by the first control section 11 is shown in FIG. 6.

The second control section 21 periodically notifies the first control unit 10 of the download condition X2 in the memory 23 (Act 211). If the download condition X3 is notified from the third control unit 30 (YES in Act 212), the second control section 21 updates and stores the download condition X3 in the memory 23 (Act 213). If the data D2 to be downloaded to the second control unit 20 is transferred from the first control unit 10 (YES in Act 214 and YES in Act 215), the second control section 21 accepts the data D2 and stores the data D2 in the memory 23 (Act 216). If the data D3 to be downloaded to the third control unit 30 is transferred from the first control unit 10 (YES in Act 214 and NO in Act 215), the second control section 21 determines whether the data D3 meets the download condition X3 in the memory 23 (Act 217). If the data D3 meets the download condition X3 (YES in Act 218), the second control section 21 transfers the data D3 to the third control unit 30 (Act 219). If the data D3 does not meet the download condition X3 (NO in Ac 218), the second control section 21 informs the first control unit 10 that the download to the third control unit 30 is error (Act 220).

If the download condition X2 is notified from the second control unit 20 (YES in Act 131), the first control section 11 updates and stores the download condition X2 in the memory 23 (Act 132).

If data transmitted from the server 50 is input via the communication network 40 (YES in Act 133), the first control section 11 determines to which control unit the input data is to be downloaded (Acts 134, 136, and 141). If the input data is the data D3 to be downloaded to the third control unit 30 (YES in Act 134), the first control section 11 transfers the data D3 to the second control unit 20 (Act 135).

If the input data is the data D2 to be downloaded to the second control unit 20 (YES in Act 136), the first control section 11 determines whether the data D2 meets the download condition X2 in the memory 23 (Act 137). If the data D2 meets the download condition X2 (YES in Act 138), the first control section 11 transfers the data D2 to the second control unit 20 (Act 139). If the data D2 does not meet the download condition X2 (NO in Act 138), the first control section 11 informs, through display by the operation and display section 14, that the download to the second control unit 20 is error (Act 140).

If the input data is the data D1 to be downloaded to the first control unit 10 (YES in Act 141), the first control section 11 determines whether the data D1 meets the download condition X1 in the memory 13 (Act 142). If the data D1 meets the download condition X1 (YES in Act 143), the first control section 11 accepts the data D1 and stores the data D1 in the memory 13 (Act 144). If the data D1 does not meet the download condition X1 (No in Act 143), the first control section 11 informs, through display by the operation and display section 14 that the download to the first control unit 10 is error (Act 145).

If the first control section 11 is notified from the second control unit 20 that the download to the third control unit 30 is error (YES in Act 146), the first control section 11 informs, through display by the operation and display section 14, that the download to the third control unit 30 is error (Act 147).

As explained above, the data D3 that does not meet the download condition X3 for the third control unit 30 is not transferred from the second control unit 20 to the third control unit 30. Therefore, useless data transfer processing can be prevented. A waste of time required for the data transfer processing can be eliminated. The user can easily grasp by looking at the display by the operation and display section 14 that the download to the third control unit 30 is error. The first control unit 10 may inform, via the communication network 40, the server 50 that the download to the third control unit 30 is error.

The data D2 that does not meet the download condition X2 for the second control unit 20 is not transferred from the first control unit 10 to the second control unit 20. Therefore, useless data transfer processing can be prevented. A waste of time required for the data transfer processing can be eliminated. The user can easily grasp by looking at the display by the operation and display section 14 that the download to the second control unit 20 is error. The first control unit 10 may inform, via the communication network 40, the server 50 that the download to the second control unit 20 is error.

The data D1 that does not meet the download condition X1 for the first control unit 10 is not accepted by the first control unit 10. The user can easily grasp by looking at the display by the operation and display section 14 that the download to the first control unit 10 is error. The first control unit 10 may inform, via the communication network 40, the server 50 that the download to the first control unit 10 is error.

[3] A third embodiment is explained below.

The configuration of the printer 1 is the same as that shown in FIG. 1. The third control section 31 includes the control sections (31) and (32) same as those in the first embodiment.

The second control section 21 includes control sections (21-2) to (23-2) explained below.

(21-2) A control section configured to update and store, if the download condition X3 is notified from the third control unit 30, the download condition X3 in the memory 23.

(22-2) A control section configured to determine, if the data D2 to be downloaded to the second control unit 20 is transferred from the first control unit 10, whether the data D2 meets the download condition X2 in the memory 23, accept, if the data D2 meets the condition X2, the data D2 and store the data D2, and notify, if the data D2 does not meet the download condition X2, the first control unit 10 that the download to the second control unit 20 is error.

(23-2) A control section configured to determine, if the data D3 to be downloaded to the third control unit 30 is transferred from the first control unit 10, whether the data D3 meets the updated and stored download condition X3, transfer, if the data D3 meets the download condition X3, the data D3 to the third control unit 30, and notify, if the data D3 does not meet the download condition X3, the first control unit 10 that the download to the third control unit 30 is error.

The first control section 11 includes control sections of (11-2) to (13-2) explained below.

(11-2) A control section configured to transfer, if the data D3 to be downloaded to the third control unit 30 is input from the outside, the data D3 to the second control unit 20.

(12-2) A control section configured to transfer, if the data D2 to be downloaded to the second control unit 20 is input from the outside, the data D2 to the second control unit 20.

(13-2) A control section configured to determine, if the data D1 to be downloaded to the first control unit 10 is input from the outside, whether the data D1 meets the download condition X1 in the memory 13, accept, if the data D1 meets the download condition X1, the data D1 and store the data in the memory 13, and inform, if the data D1 does not meet the download condition X1, through display by the operation and display section 14, that the download to the first control unit 10 is error.

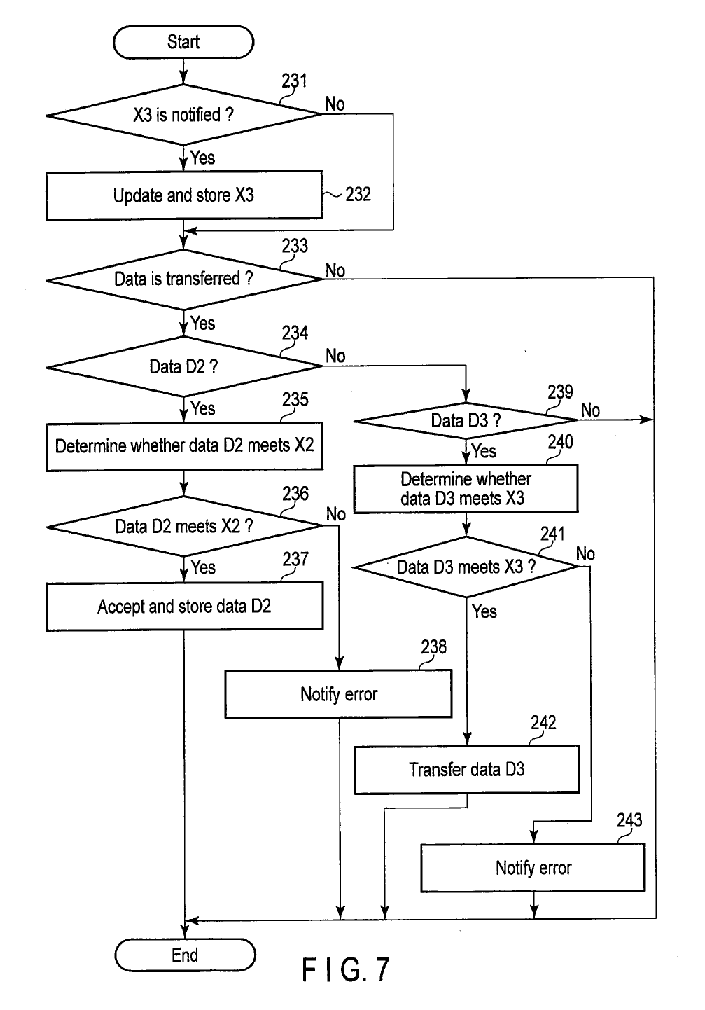

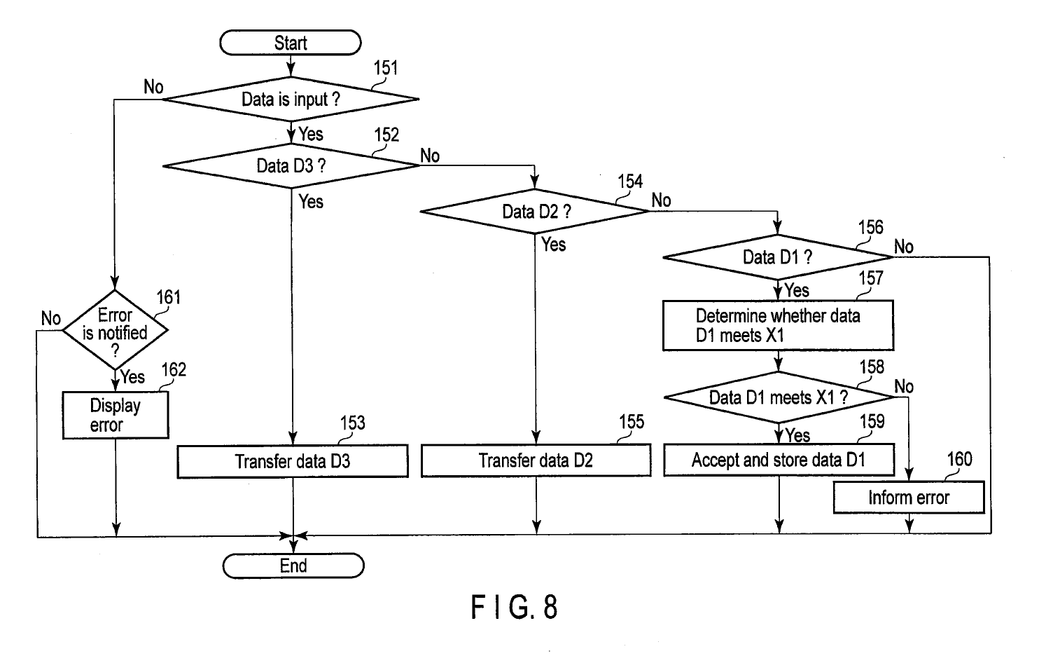

Since control by the third control section 31 is the same as that in the first embodiment, explanation of the control is omitted. Control by the second control section 21 is shown in FIG. 7. Control by the first control section 11 is shown in FIG. 8.

If the download condition X3 is notified from the third control unit 30 (YES in Act 231), the second control section 21 updates and stores the download condition X3 in the memory 23 (Act 232).

If the data D2 to be downloaded to the second control unit 20 is transferred from the first control unit 10 (YES in Act 233 and YES in Act 234), the second control section 21 determines whether the data D2 meets the download condition X2 in the memory 23 (Act 235). If the data D2 meets the download condition X2 (YES in Act 236), the second control section 21 accepts the data D2 and stores the data D2 in the memory 23 (Act 237). If the data D2 does not meet the download condition X2 (NO in Act 236), the second control section 21 notifies the first control unit 10 that the download to the second control unit 20 is error (Act 238).

If the data D3 to be downloaded to the third control unit 30 is transferred from the first control unit 10 (YES in Act 233, NO in Act 234, and YES in Act 239), the second control section 21 determines whether the data D3 meets the download condition X3 in the memory 23 (Act 240). If the data D3 meets the download condition X3 (YES in Act 241), the second control section 21 transfers the data D3 to the third control unit 30 (Act 242). If the data D3 does not meet the download condition X3 (NO in Act 241), the second control section 21 notifies the first control unit 10 that the download to the third control unit 30 is error (Act 243).

If data transmitted from the server 50 is input via the communication network 40 (YES in At 151), the first control section 11 determines to which control unit the input data is to be downloaded (Acts 152, 154, and 156). If the input data is the data D3 to be downloaded to the third control unit 30 (YES in Act 152), the first control section 11 transfers the data D3 to the second control unit 20 (Act 153). If the input data is the data D2 to be downloaded to the second control unit 20 (YES in Act 154), the first control section 11 transfers the data D2 to the second control unit 20 (Act 155).

If the input data is the data D1 to be downloaded to the first control unit 10 (YES in Act 156), the first control section 11 determines whether the data D1 meets the download condition X1 in the memory 13 (Act 157). If the data D1 meets the download condition X1 (YES in Act 158), the first control section 11 accepts the data D1 and stores the data D1 in the memory 13 (Act 159). If the data D1 does not meet the download condition X1 (NO in Act 158), the first control section 11 informs, through display by the operation and display section 14, that the download to the first control unit 10 is error (Act 160).

If the first control section 11 is notified from the second control unit 20 that the download to the second control unit 20 is error (YES in Act 161) and if the first control section 11 is notified from the second control unit 20 that the download to the third control unit 30 is error (YES in Act 161), the first control section 11 informs, through display by the operation and display section 14, that the download to the second control unit 20 and the download to the third control unit 30 are error (Act 162).

As explained above, the data D3 that does not meet the download condition X3 for the third control unit 30 is not transferred from the second control unit 20 to the third control unit 30. Therefore, useless data transfer processing can be prevented. A waste of time required for the data transfer processing can be eliminated. The user can easily grasp by looking at the display by the operation and display section 14 that the download to the third control unit 30 is error. The first control unit 10 may inform, via the communication network 40, the server 50 that the download to the third control unit 30 is error.

The user can easily grasp by looking at the display by the operation and display section 14 that the download to the second control unit 20 is error. The first control unit 10 may inform, via the communication network 40, the server 50 that the download to the second control unit 20 is error.

The user can easily grasp by looking at the display by the operation and display section 14 that the download to the first control unit 10 is error. The first control unit 10 may inform, via the communication network 40, the server 50 that the download to the first control unit 10 is error.

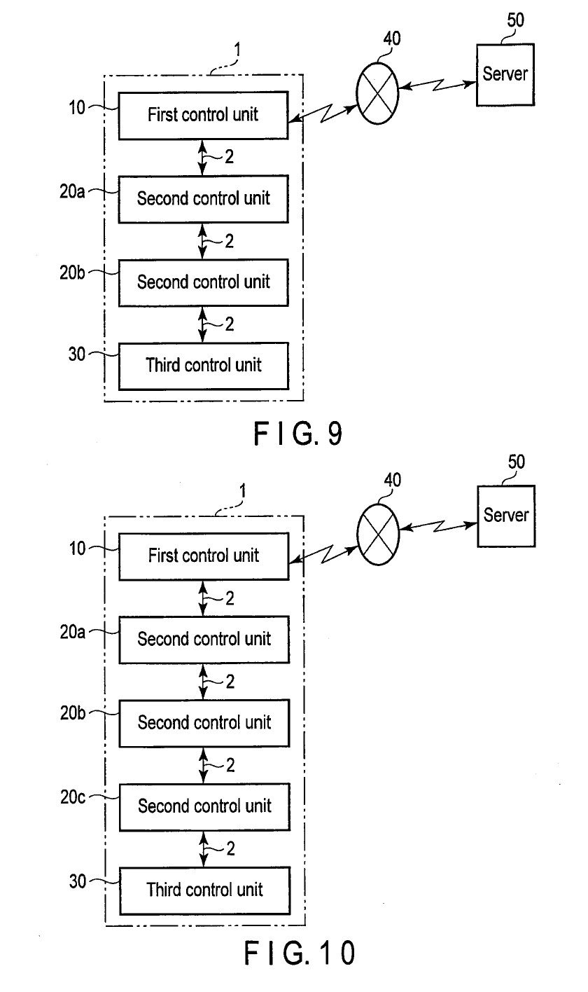

### Modifications

[4] If two second control units 20a and 20b having the same function are present, the first control unit 10, the second control unit 20a, the second control unit 20b, and the third control unit 30 are serially connected as shown in FIG. 9. In this case, effects same as those in the embodiments can be obtained.

If three second control units 20a, 20b, and 20c having the same function are present, the first control unit 10, the second control unit 20a, the second control unit 20b, the second control unit 20c, and the third control unit 30 are serially connected as shown in FIG. 10. In this case, effects same as those in the embodiments can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
first, second, and third control units having a high rank and low rank relation with one another and serially connected in order from a high rank control unit to a low rank control unit;
a third control section arranged in the third control unit and configured to notify the second control unit of a third download condition for the third control unit;
a second control section arranged in the second control unit and configured to notify the first control unit of a second download condition for the second control unit, notify the first control unit of a third download condition notified from the third control unit, and transfer, if third data to be downloaded to the third control unit is transferred from the first control unit, the third data to the third control unit; and
a first control section arranged in the first control unit and configured to determine, if second data to be downloaded to the second control unit is input from an outside, whether the second data meets the second download condition notified from the second control unit, transfer, if the second data meets the second download condition, the second data to the second control unit, determine, if the third data to be downloaded to third control unit is input from the outside, whether the third data meets the third download condition notified from the second control unit, and transfer, if the third data meets the third download condition, the third data to the second control unit.

2. The printer of claim 1, wherein the first control section informs, if the second data input from the outside does not meet the second download condition notified from the second control unit, that the download to the second control unit is error and informs, if the third data input from the outside does not meet the third download condition notified from the second control unit, that the download to the third control unit is error.

3. The printer of claim 1, wherein the third control section periodically notifies the second control unit of the third download condition.

4. The printer of claim 1, wherein the second control section periodically notifies the first control unit of the second download condition and notifies, if the third download condition is notified from the third control unit, the first control unit of the third download condition.

5. The printer of claim 1, wherein the first control section updates and stores, if the second download condition is notified from the second control unit, the second download condition and updates and stores, if the third download condition is notified from the second control section, the third download condition.

6. The printer of claim 1, wherein the third control section accepts, if the third data is transferred from the second control unit, the third data and stores the third data.

7. The printer of claim 1, wherein the second control section accepts, if the second data is transferred from the first control unit, the second data and stores the second data.

8. The printer of claim 1, wherein the first control section determines, if first data to be downloaded to the first control unit is input from the outside, whether the first data meets a first download condition for the first control unit and accepts, if the first data meets the first download condition, the first data and stores the first data.

9. The printer of claim 8, wherein the first control section informs, if the first data does not meet the first download condition, that the download to the first control unit is error.

10. A printer comprising:
first, second, and third control units having a high rank and low rank relation with one another and serially connected in order from a high rank control unit to a low rank control unit;
a third control section arranged in the third control unit and configured to notify the second control unit of a third download condition for the third control unit;
a second control section arranged in the second control unit and configured to notify the first control unit of a second download condition for the second control unit, determine, if third data to be downloaded to the third control unit is transferred from the first control unit, whether the third data meets a third download condition notified from the third control unit, and transfer, if the third data meets the third download condition, the third data to the third control unit; and
a first control section arranged in the first control unit and configured to determine, if second data to be downloaded to the second control unit is input from an outside, whether the second data meets the second download condition notified from the second control unit, transfer, if the second data meets the second download condition, the second data to the second control unit, and transfer, if the third data to be downloaded to the third control unit is input from the outside, the third data to the second control unit.

11. The printer of claim 10, wherein
the second control section informs, if the third data transferred from the first control unit does not meet the third download condition notified from the third control unit, the first control unit that the download to the third control unit is error, and
the first control section informs, if the second data input from the outside does not meet the second download condition notified from the second control unit, that the download to the second control unit is error and informs, if notification that the download to the third control unit is error is accepted from the second control unit, that the download to the third control unit is error.

12. The printer of claim 10, wherein the third control section periodically notifies the second control unit of the third download condition.

13. The printer of claim 10, wherein the second control section periodically notifies the first control unit of the second download condition and updates and stores, if the third download condition is notified from the third control unit, the third download condition.

14. The printer of claim 10, wherein the first control section updates and stores, if the second download condition is notified from the second control unit, the second download condition.

15. The printer of claim 10, wherein
the third control section accepts, if the third data is transferred from the second control unit, the third data and stores the third data,
the second control section accepts, if the second data is transferred from the first control unit, the second data and stores the second data, and
the first control section determines, if first data to be downloaded to the first control unit is input from the outside, whether the first data meets a first download condition for the first control unit and accepts, if the first data meets the first download condition, the first data and stores the first data.

16. The printer of claim 15, wherein the first control section informs, if the first data input from the outside does not meet the first download condition, that the download to the first control unit is error.

17. A control method for a printer including first, second, and third control units having a high rank and low rank relation with one another and serially connected in order from a high rank control unit to a low rank control unit, the method comprising:
notifying the second control unit of a third download condition for the third control unit from the third control unit;
notifying the first control unit of a second download condition for the second control unit from the second control unit;
notifying the first control unit of a third download condition notified from the third control unit to the second control unit;
transferring, if third data to be downloaded to the third control unit is transferred from the first control unit to the second control unit, the third data from the second control unit to the third control unit;
determining, if second data to be downloaded to the second control unit is input from an outside to the first control unit, whether the second data meets the second download condition notified from the second control unit and transferring, if the second data meets the second download condition, the second data from the first control unit to the second control unit; and
determining, if the third data to be downloaded to third control unit is input from the outside to the first control unit, whether the third data meets the third download condition notified from the second control unit, and transferring, if the third data meets the third download condition, the third data from the first control unit to the second control unit.
